(19) United States
(12) Patent Application Publication
(10) Pub. No.: US 2016/0274653 A1
(43) Pub. Date: Sep. 22, 2016

(54) POWER DEMAND MANAGEMENT FOR MULTIPLE SOURCES OF ENERGY

(71) Applicant: Customized Energy Solutions, Ltd., Philadelphia, PA (US)

(72) Inventor: Vaclav Mydlil, Issaquah, WA (US)

(21) Appl. No.: 15/071,984

(22) Filed: Mar. 16, 2016

Related U.S. Application Data
(60) Provisional application No. 62/133,852, filed on Mar. 16, 2015.

(51) Int. Cl. G06F 1/32; G06F 1/26

(52) U.S. Cl. CPC G06F 1/3296; G06F 1/26

(57) ABSTRACT

A computer-implemented method for managing power demand includes a computer system obtaining power demand information for a facility comprising one or more local energy storage devices and one or more power loads. The computer system selects a demand management action from a plurality of available demand management actions based on the power demand information. These available demand management actions comprise at least one power load action and at least one energy storage device action. Once selected, the computer system performs the selected demand management action.

### CROSS-REFERENCE TO RELATED APPLICATIONS

This application claims the benefit of priority of U.S. Provisional Patent Application No. 62/133,852, filed Mar. 16, 2015, the entirety of which is hereby incorporated by reference herein.

### TECHNOLOGY FIELD

The present invention relates generally to methods, systems, and apparatuses for power demand management managing power demand with multiple sources of energy such as reduction of existing electric loads, locally stored energy (e.g., in the form of batteries), and newly generated energy (including renewable energy such as wind, solar, or hydro power), which may be generated locally or provided through a public power grid.

### BACKGROUND

Most electric utility companies charge industrial and commercial customers not only for total energy usage (kWh), but also for power demand (kW) averaged over a debit period (e.g., an interval of 5, 10, 15, or 60 minutes, or some other length of time). Power demand may include power usage associated with one or more power loads. The particular number of power loads and the nature of the power loads can vary depending on the facility being analyzed.

Facilities with power and energy requirements can benefit from automated power control systems that reduce power demand in order to control costs. Load control-based demand management systems can control demand by temporarily reducing power of contributing electric loads, but standalone load control systems do not have the ability to take advantage of local sources of power. Energy storage-based demand management systems can control demand by storing energy during debit periods with low overall demand and releasing the energy during debit periods with high overall demand. However, standalone energy storage systems do not have the ability to reduce demand of contributing loads, which reduces their return on investment (ROI) because of high initial costs and ongoing operating costs (e.g., costs associated with battery/inverter efficiency limitations).

It would be useful to combine the benefits of load control-based and energy storage-based demand control systems into a cohesive system. However, in order to properly obtain the benefits of combining such systems, an integrated approach is needed to avoid potential conflicts or inefficiencies that may be introduced.

### SUMMARY

Embodiments of the present invention address and overcome one or more of the above shortcomings and drawbacks, by providing a power demand management managing power demand with multiple sources of energy. Briefly, an integrated demand management system is described herein which compensates for variability in power demand and output by using prioritized demand management actions that are directed to, for example, reducing loads or using stored energy. The integrated approach applied by the integrated demand management system increases overall demand management effectiveness by intelligently combining the demand management effects of load control and energy storage control. The integrated approach allows energy storage devices of any storage capacity to contribute to the overall system.

According to some embodiments of the present invention, a computer-implemented method for managing power demand includes a computer system obtaining power demand information for a facility comprising one or more local energy storage devices and one or more power loads. The computer system selects a demand management action from a plurality of available demand management actions based on the power demand information. These available demand management actions comprise at least one power load action and at least one energy storage device action. Once selected, the computer system performs the selected demand management action.

In some embodiments of the aforementioned method for managing power demand, the power demand information comprises a demand limit set-point and a predicted power demand value. The method described above may then further include calculating an available power value as a difference between the predicted power demand value and the demand limit set-point. Once calculated, the available power value may be used for selecting the demand management action. If the available power value is negative, the selected demand management action may be selected from a group comprising increasing a load reduction, reducing charging power, and increasing power generation. Alternatively, if the available power value is positive, the selected demand management action may be selected from a group comprising decreasing a load reduction, charging an energy storage device, and decreasing power generation.

According to other embodiments, a second computer-implemented method for managing power demand includes a computer system obtaining power demand information for a time period comprising a plurality of intervals. The power demand information comprises a demand limit set-point for the time period and a predicted power demand value for the time period. The computer system determines that the predicted power demand value exceeds the demand limit set-point and, in response, available power is drawn to reduce the power demand for the time period. The available power may include, for example, one or more local power sources and available reduction of one or more of the power loads. The drawing from the available power may include, for example, reducing at least one of the power loads for at least one of the intervals. Alternatively (or additionally), the drawing may include generating power from at least one of the local power sources (e.g., an energy storage device).

In some embodiments of the aforementioned second method for managing power demand, the drawing from available power is based on priority information. This priority information may comprise, for example, information for the power loads and/or information for the local power sources. In some instances, the priority information may be organized in a plurality of prioritized segments.

In other embodiments, a system for managing power demand includes one or more ports and one or more processors. The ports are configured to obtain power demand information for a facility comprising one or more local energy storage devices and one or more power loads. The processors are configured to select a demand management action from a plurality of available demand management actions based on the power demand information. These available demand management actions comprise at least one power load action and at least one energy storage device action. The processors are further configured to perform the selected demand management action. Additionally, in some embodiments, the processors may be configured to calculate an available power value as a difference between the predicted power demand value and the demand limit set-point. The selected demand management action may then be based, at least in part, on the available power value.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1A is a block diagram depicting an illustrative system in which electrical power consumption by a facility is managed by an integrated demand management system, according to some embodiments;

FIG. 1B is a block diagram depicting a detailed illustration of the integrated demand management system, according to some embodiments;

FIG. 2 illustrates a timing scale of billing periods divided into debit periods, as may be utilized in some embodiments;

FIG. 3 illustrates a method that the integrated demand management system uses integrated approaches to control demand, according to some embodiments;

FIG. 4 illustrates an additional method that the integrated demand management system uses integrated approaches to control demand, according to some embodiments;

FIG. 5A illustrates a first portion of method performed by the integrated demand management system, according to some embodiments, where a detailed, integrated approach is used to control demand;

FIG. 5B illustrates the second portion of method illustrated in FIG. 5A;

FIG. 6A includes a table illustrating power availability in a facility which includes five power loads and two energy storage devices;

FIG. 6B a second table with subinterval information illustrating how the demand management algorithm described herein can request load and storage power segments, according to some embodiments;

FIG. 7 is a block diagram that illustrates aspects of an illustrative computing device appropriate for use in accordance with embodiments of the present disclosure; and

FIG. 8 is a block diagram that illustrates aspects of an alternate computing environment appropriate for use in accordance with embodiments of the present disclosure.

### DETAILED DESCRIPTION

The following disclosure describes the present invention according to several embodiments directed at methods, systems, and apparatuses for managing power demand with multiple sources of energy. The sources of energy may include one or more of: reduction of existing electric loads, locally stored energy (e.g., in the form of batteries), and newly generated energy (e.g., renewable energy such as wind, solar, or hydro power), which may be generated locally or provided through a public power grid. Although some renewable energy sources (such as wind and solar power) are characterized by power output variability, an integrated demand management system can compensate for such variability by using prioritized demand management actions that are directed to, for example, reducing loads or using stored energy. More broadly, prioritization can be used to determine whether any number of power sources may be used, and to what extent, in a particular situation to manage demand (e.g., by favoring the use of cheaper and more efficient power sources and using more expensive sources of power less frequently).

The embodiments described herein increase overall demand management effectiveness with an integrated approach that intelligently combines the demand management effects of load control and energy storage control. The integrated approach allows energy storage devices of any storage capacity to contribute to the overall system. Energy storage devices typically contain one or more batteries and an inverter, which converts alternating current (AC) power to direct current (DC) power for battery charging and DC power to AC power for battery discharging. However, an energy storage device also may use an energy storage medium other than a battery. For example, mechanical energy storage devices, such as flywheels (a spinning wheel connected to a motor/generator) and hydroelectric storage (e.g., water pumped to a reservoir and released later to power a generator), may be used. The integrated approach also increases demand management potential during demand response events, allowing rapid, automated responses to opportunities for cost savings through demand reduction.

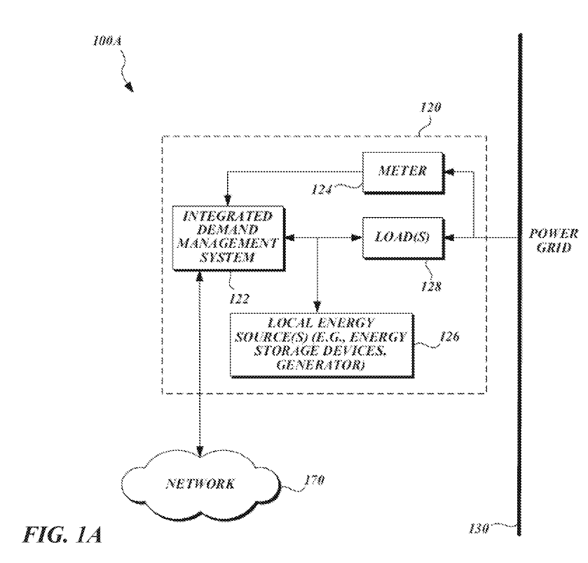

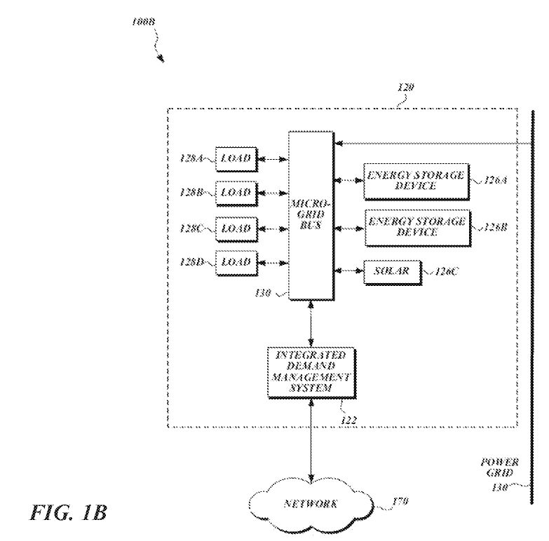

FIG. 1A is a block diagram depicting an illustrative system 100A in which electrical power consumption by a facility 120 (e.g., a factory, a warehouse, an office building, a home, a school or government building, a data or computing center, or any other facility that consumes power) is managed by an integrated demand management system 122, according to some embodiments. Briefly, the integrated demand management system 122 increases overall demand management efficiency by applying an integrated demand management algorithm to multiple available energy sources (e.g., available energy from reduction of loads 128, locally stored energy sources 126, and a public utility's power grid 130). The system also increases overall demand management efficiency by its ability to prioritize and constrain demand management actions directed to individual energy sources.

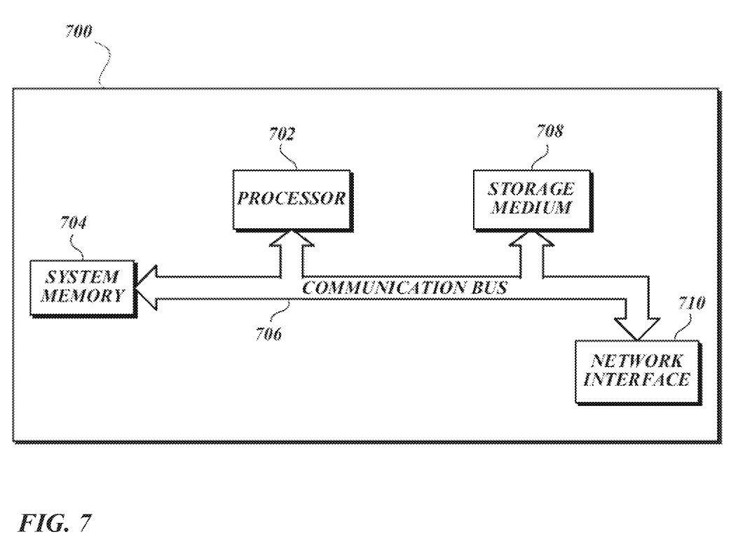

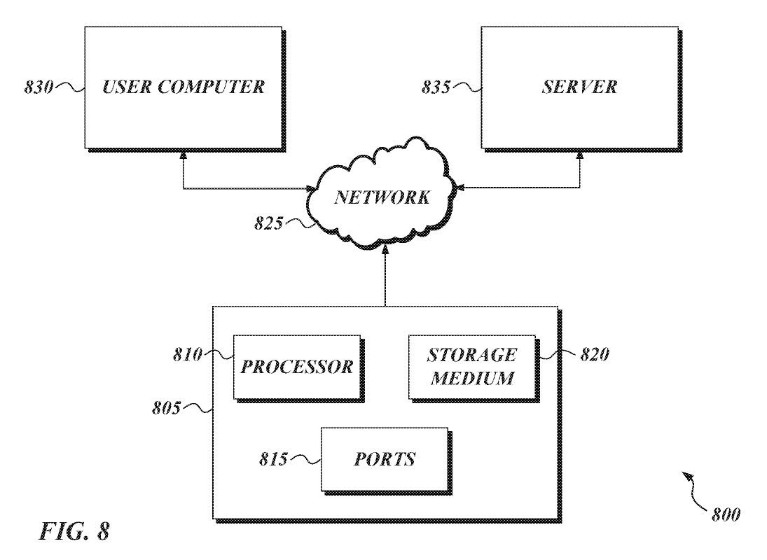

In the example shown in FIG. 1A, the facility 120 draws power from a power grid 130, which may be maintained at least in part by a power utility (not shown). The integrated demand management system 122 may be implemented in one or more computing devices, such as suitably programmed computers or microcontrollers (see FIGS. 7 and 8). The integrated demand management system 122 applies specialized processing to power demand information in a way that allows the facility 120 to benefit from one or more of the power demand management techniques described herein. A power meter 124 can provide readings of ongoing energy consumption to the integrated demand management system 122.

The power demand information may include, for example, a demand limit set-point and a predicted power demand value. The demand limit set-point represents a target demand level; typically, the target demand level is not to be exceeded in order to avoid additional demand charges, although it can be exceeded if practical considerations prevent, or outweigh the benefits of, keeping the demand level below the target demand level. (For more information on techniques for controlling demand, see U.S. patent application Ser. No. 12/201,911, entitled “Automated Peak Demand Controller,” filed on Aug. 29, 2008, the entirety of which is incorporated herein by reference.) If the predicted power demand value will exceed the demand limit set-point if current demand is sustained, action can be taken to reduce power of contributing loads, request power generation from energy storage, etc., as described in detail below.

There are different ways to provide power demand information to the integrated demand management system 122. Power demand information may be stored within the facility 120 (e.g., within the integrated demand management system 122 or in some other location) and/or provided by a separate computer system (not shown) via a network 170 (e.g., the Internet). For example, power demand information can be provided by one or more server computers hosted by a power utility or a demand management service provider. Such a service provider also may provide (e.g., via network 170) software updates, Web-based software applications, remote processing or data storage capabilities (e.g., in a cloud computing environment), and/or the like, related to demand management.

The integrated demand management system 122 provides an integrated solution for managing demand through refined control of the loads 128 and local power sources 126. The integrated demand management system 122 is communicatively connected to one or more electric loads 128 and one or more local power sources 126 (e.g., energy storage devices, generators, etc.) associated with the facility 120, allowing the system to control the loads and power sources as needed for demand management. The amount of power that the facility 120 draws from the power grid varies based on its demand, and the demand varies based on factors such as the power consumed by the loads 128 and the power generated by the local energy sources 126. The integrated demand management system 122 uses power demand information to select from available demand management actions (as described in detail below), which can then be applied to the loads 128 and/or local power sources 126 to manage demand.

FIG. 1B is a block diagram depicting a more detailed system 100B. In the example shown in FIG. 1B, the integrated demand management system 122 is communicatively connected to several loads 128A-D (e.g., an HVAC system, a pump motor, a furnace, process controls, etc.) and several local power sources 126A-C (e.g., two energy storage devices and a solar power generator) associated with the facility 120. In the example shown in FIG. 1B, the integrated demand management system 122 communicates and controls the loads 128A-D and local power sources 126A C via a micro-grid bus 130.

Although specific arrangements are shown in FIGS. 1A and 1B for purposes of illustration, many alternatives to the systems shown in FIGS. 1A and 1B are possible. For example, the systems can be designed to work “off-line,” without a network connection, by using locally stored information. As another example, although the systems 100A and 100B are shown with only one facility for ease of illustration, such systems may include more than one facility. Separate facilities may be managed by a single integrated demand management system 122 or by multiple such systems (e.g., one per facility). It is also possible for a suitably configured integrated demand management system 122 to manage demand in more than one facility.

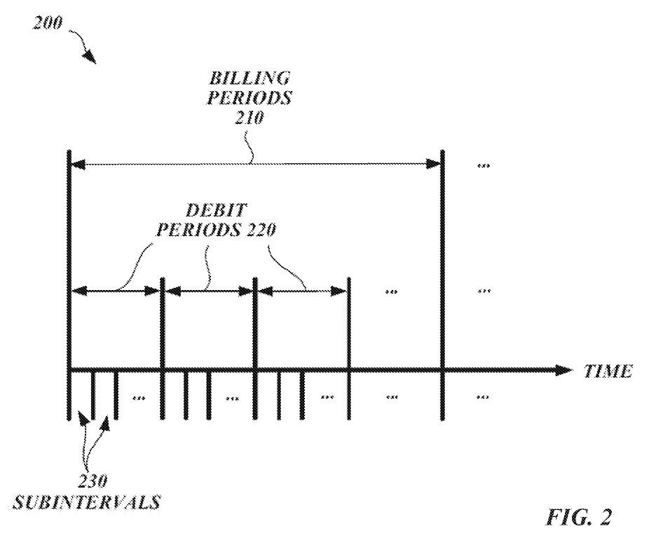

The systems illustrated in FIGS. 1A and 1B can function within particular timing parameters, which may be described in terms of intervals and subintervals. In one usage scenario, a billing period (e.g., one month) is defined by a power utility, and is divided into intervals called debit periods. A debit period (e.g., 15, 30, or 60 minutes) typically is also defined by the utility, and may be divided into subintervals defined by an integrated demand management system. FIG. 2 illustrates an illustrative timing scale 200 of billing periods 210 divided into debit periods 220, with each debit period being further divided into subintervals 230. As shown, the billing periods 210 may be divided into any suitable number of debit periods 220, and the debit periods 220 may be divided into any suitable number of subintervals 230. It will be understood that the length and exact number of intervals (e.g., debit periods) and subintervals used by the systems 100A and 100B may vary depending on utility requirements, system design, or other factors.

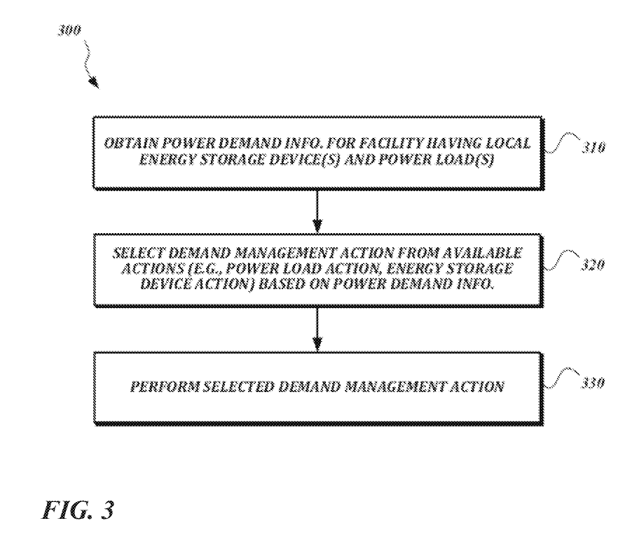

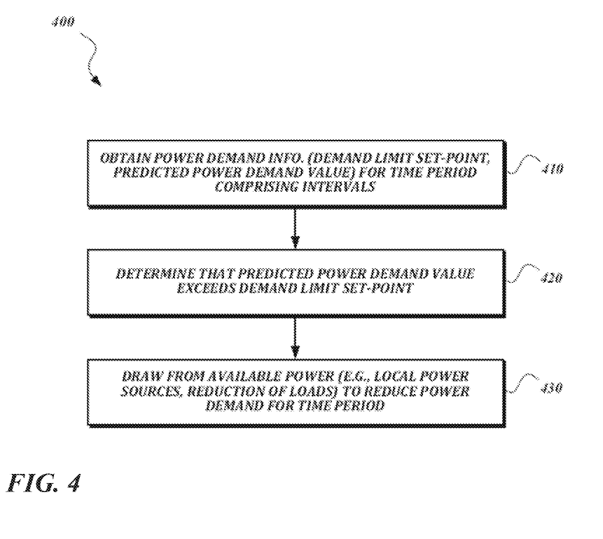

In illustrative methods 300 and 400 described with reference to FIGS. 3 and 4, an integrated demand management system uses integrated approaches to control demand. In the example shown in FIG. 3, at step 310 the integrated demand management system obtains power demand information (e.g., a demand limit set-point and a predicted power demand value) for a facility having one or more local energy storage devices and one or more power loads. At step 320, the system selects a demand management action from a plurality of available demand management actions that include at least one power load action (e.g., reducing a power load or decreasing the amount of a previous reduction of a power load) and at least one energy storage device action (e.g., charging or discharging). At step 330, the system performs the selected action.

In at least one embodiment, an available power value is calculated as a difference between the predicted power demand value and the demand limit set-point, and the selected action is based on the available power value. For example, if the available power value is negative, the selected action may be reducing a load, reducing charging power, or increasing power generation. If the available power value is positive, the selected action may be decreasing an existing load reduction, charging an energy storage device, or decreasing power generation.

In the example shown in FIG. 4, at step 410 the integrated demand management system obtains power demand information comprising a demand limit set point and a predicted power demand value for a time period (e.g., a debit period) comprising intervals. At step 420, the system determines that the predicted power demand value exceeds the demand limit set-point, and at step 430, the system draws from available power to reduce demand for the time period. The available power includes one or more local power sources (e.g., energy storage devices, solar power generators, etc.) and available reduction of one or more power loads. Drawing from the available power may include reducing a power load or generating power from a local power source. The system may draw from the available power based on priority information, which may include prioritized segments for the loads or local power sources. Prioritization of loads and power sources is discussed in more detail below.

### Detailed Examples

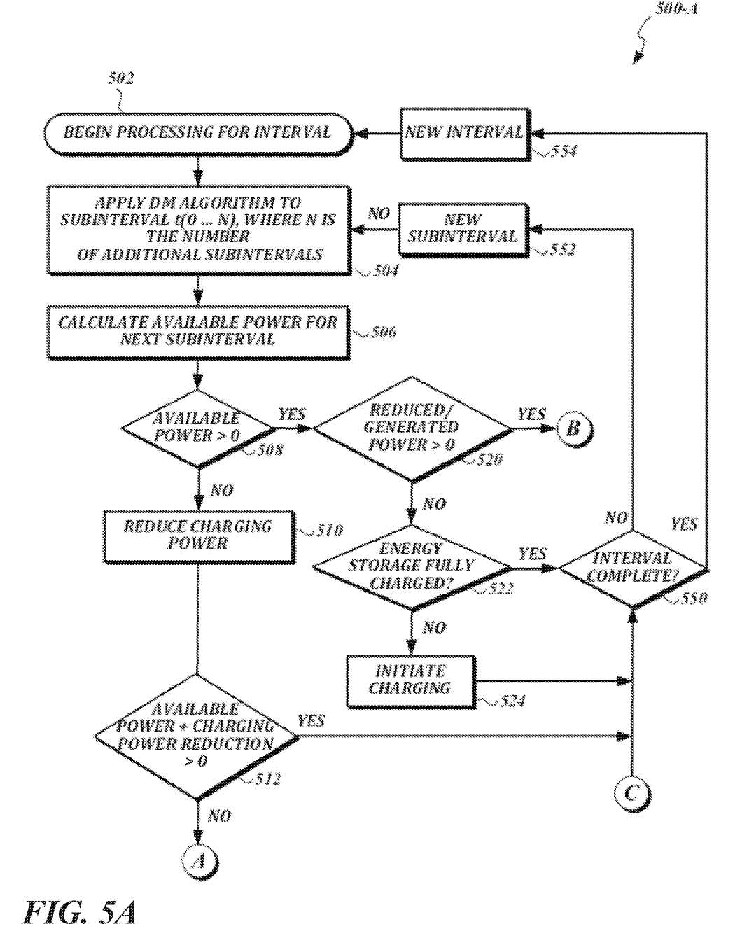

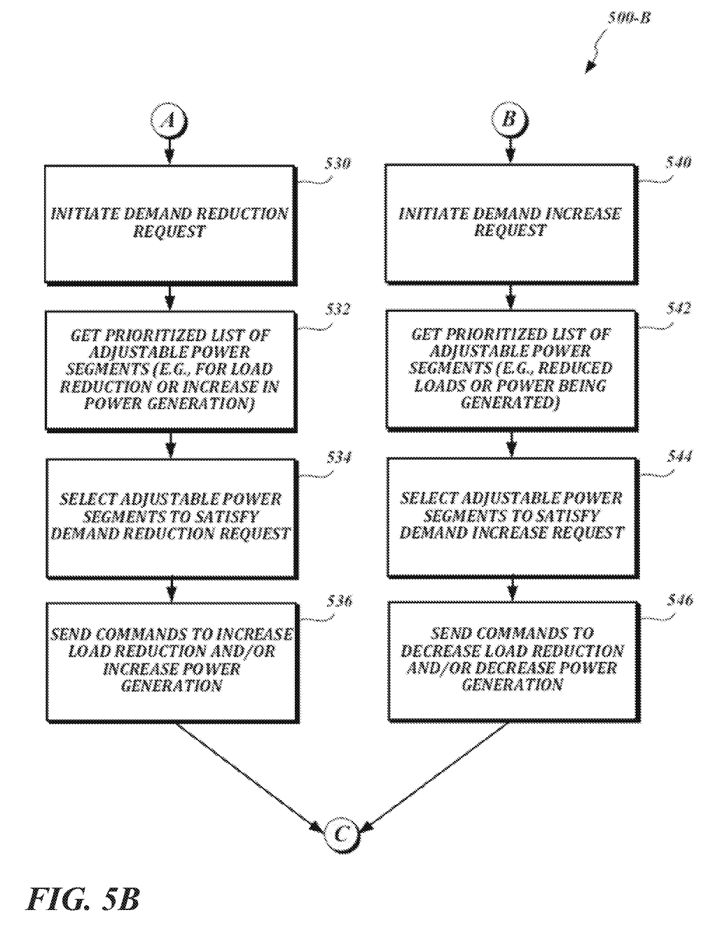

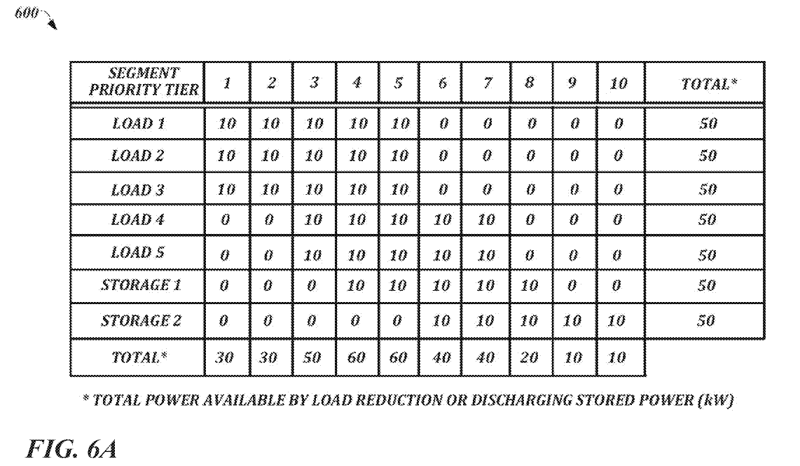

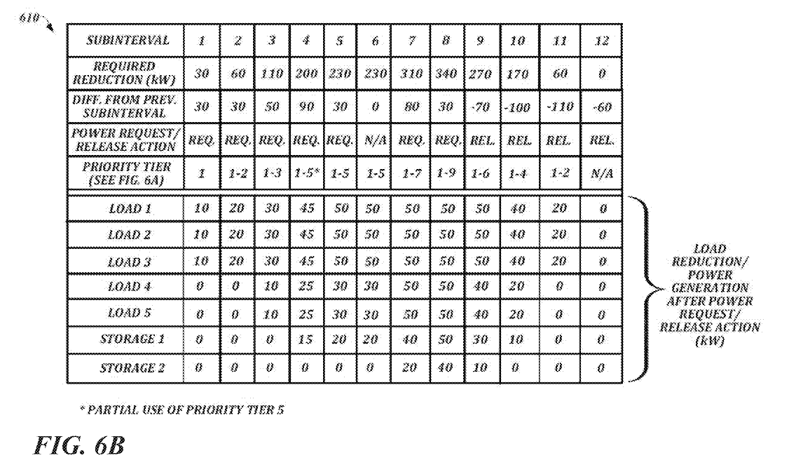

The following examples provide additional details of principles described herein, with reference to FIGS. 5A-6B. It should be understood that the details provided herein are non-limiting and may vary depending on the details of other implementations in accordance with the principles described herein.

In an illustrative method described with reference to FIGS. 5A and 5B, an integrated demand management system uses a detailed, integrated approach to control demand. In this example, the system increases overall demand management efficiency by applying an integrated demand management algorithm to multiple energy sources (e.g., some or all of a facility's available energy sources). The system keeps track of available power, which individual energy sources can contribute at a given time to manage demand.

The available power of an energy storage device is the rated power the storage can supply at the given moment, plus any charging power. The available power of a running electrical load is the portion that can be temporarily reduced. Constraints can be specified (e.g., by a user) for loads, and the calculation of available power can take such constraints into account. For example, in a facility that needs to be heated to a minimum temperature, a constraint can be placed on a heating load to avoid reducing the heating load below a particular specified level. It may be possible to reduce the heating load in order to manage demand, but available power from such a reduction may be limited by the constraint. Similar constraints could be specified for a cooling system load in a facility that must remain below a maximum temperature. Such constraints can be applied in addition to priority information for the loads, which may designate the loads as being more or less critical than other loads.

The algorithm works with a demand limit set-point. In this example, the demand limit set point defines a maximum average power allowed during a debit period. The actual average power at any given moment within a debit period can be determined by obtaining a reading of the utility meter energy usage data. In at least one embodiment, the demand management algorithm calculates the slope of actual power demand averaged over a configurable period of time, and calculates whether the demand limit will be exceeded if the current demand is sustained. If the algorithm determines that the demand limit will be exceeded, the integrated demand management system can issue commands to perform demand management actions, e.g., reducing power of contributing loads, requesting power generation from energy storage, or other actions or combinations of actions (such as reducing loads and generating power at the same time). In this way, the algorithm is able to control both loads and power generation by treating them as one energy pool, with power generation being treated as a reversed load.

The system also can increase overall demand management efficiency by its ability to prioritize and constrain demand management actions directed to individual energy sources. Priorities can be predefined in a number of ways (e.g., by an operator) or dynamically assigned (e.g., according to rules that take into account factors such as current and future costs of energy, production factors, and energy storage efficiencies). Prioritization of energy sources allows interweaving of loads and energy storage in demand management actions. For example, it may be desirable to begin with demand management actions that reduce loads that are not critical to the facility's operations, before requesting power from an energy storage device or reducing loads that are more critical. At other times, it may be beneficial to begin with generating power from a high efficiency energy storage device before reducing any loads or adding power from less efficient energy sources. The system allows any available power source to be used to manage demand.

In the example illustrated with reference to flow diagrams 500-A and 500-B in FIGS. 5A and 5B, at step 502 the system begins processing for an interval (e.g., a debit period) divided into subintervals of equal duration. At step 504, the system applies a demand management algorithm to a subinterval in this interval. First, the system calculates available power for the next subinterval at step 506. For example, the system may calculate available power based on current power demand, how much demand is available for the remainder of the debit period, and how much time is remaining in the debit period. The available power may be a positive or negative value.

If the available power is not positive (step 508), the system requests a reduction in energy storage charging power (if any energy storage devices are currently being charged) at step 510. For example, the system may request a reduction in charging power. The requested amount of the reduction in charging power may be, for example, up to the absolute value of the (negative-valued) available power. In at least one embodiment, charging power can be modulated in the range of 0 to 100% of the maximum charging power. This can help to ensure that the charging process does not create undesirable power demand in the context of the facility.

If the sum of the available power and the power saved by reducing charging power is positive (step 512), the system determines whether the interval is complete at step 550 and either starts a new subinterval within the interval (step 552) or starts a new interval (step 554). If the sum of the available power and the power saved by reducing charging power is not positive, the system initiates a demand reduction request at step 530 in FIG. 5B. The requested amount of the demand reduction may be, e.g., up to the absolute value of the (negative-valued) sum of the available power and the power saved by reducing charging power.

At step 532, the system gets a prioritized list of adjustable power segments (e.g., segments from loads that can be reduced, or segments from power sources that can increase power generation). At step 534, the system selects segments to satisfy the demand reduction request. At step 536, the system sends commands to increase load reduction and/or increase power generation, which has the effect of reducing demand for utility power by the facility. In at least one embodiment, such commands are sent along with the amount of demand reduction that has been requested. The system then determines whether the interval is complete at step 550 and either starts a new subinterval within the interval (step 552) or starts a new interval (step 554).

Continuing with reference to FIG. 5A, if the available power is determined to be positive at step 508, the system determines at step 520 whether loads are currently being reduced or power is currently being generated within the facility. If the system determines at step 520 that the amount of power being reduced or generated is not positive, the system determines at step 522 whether available energy storage devices are fully charged. If they are not, the system can initiate a charging process at step 524 before proceeding to step 550. In this way, the system can take advantage of situations where the available power is positive to charge energy storage devices for future use. If the charging process is initiated, the charging power can be, for example, equal to the available power, which may be offset by an available power reserve value. The reserve value can be set by a user, or it can be set automatically based on factors such as usage history or power conditions within the facility.

Referring again to step 520, if the amount of power being reduced or locally generated is positive, the system initiates a demand increase request at step 540 in FIG. 5B. The requested amount of the demand increase may be, e.g., up to the absolute value of the reduced/generated power. At step 542, the system gets a prioritized list of adjustable power segments, e.g., segments from loads that are currently being reduced, or segments from power sources that are currently generating power. At step 544, the system selects segments to satisfy the demand increase request. At step 546, the system sends commands to decrease load reduction and/or decrease power generation (e.g., decrease discharge from energy storage devices), which has the effect of increasing demand for utility power by the facility. As with charging power, energy storage discharging also can be controlled by the demand management algorithm, and can be modulated in the range of 0-100% of the maximum discharging power. In at least one embodiment, such commands are sent along with the amount of demand increase that has been requested. The system then determines whether the interval is complete at step 550 and either starts a new subinterval within the interval (step 552) or starts a new interval (step 554).

In at least one embodiment, prioritization involves the use of tiered prioritization schema. Available power can be divided by the system into several power segments, each of which can be requested by the system (e.g., as a whole tier, segments that make up a fraction of a tier, fractions of segments, etc.). The system also allows for individual prioritization of segments. Segments can be assigned a priority number, and the segments can be accessed by the demand management algorithm based on the priority number.

Referring now to the table 600 depicted in FIG. 6A, an illustrative facility includes five power loads and two energy storage devices (e.g., battery-based energy storage devices with AC/DC and DC/AC inverters). There are five available power segments of 10 kW, for a total of 50 kW, for each load and storage device. Loads 1, 2, and 3 are less critical, with segments in priority tiers 1-5. Loads 4 and 5 are more critical, with segments in priority tiers 3-7. One energy storage device (Storage 1) is more efficient, with segments in priority tiers 4-8. The other energy storage device (Storage 2) is less efficient, with segments in priority tiers 6-10. Segment priorities can be predefined but may also be changeable. For example, segment priorities may be dynamically changed based on external factors, such as where a load that was previously determined to be less critical is later deemed to more critical, or where energy storage device discharging is postponed by making it more critical. For example, if cloud cover is expected to affect solar power generation, an energy storage device may be predicted to be needed during that time to supplement some of the power, and discharging of the energy storage device can be postponed until it is needed.

In this example, the demand management algorithm can request load and storage power segments (either as whole segments or fractions of segments) for the first four subintervals in the following order, as illustrated in table 610 in FIG. 6B:
Subinterval 1: segment 1 of Loads 1-3.
Subinterval 2: segment 2 of Loads 1-3.
Subinterval 3: segment 3 of Loads 1-3; segment 1 of Loads 4-5.
Subinterval 4: segment 4 and portions of segment 5 of Loads 1-3; segment 2 and portions of segment 3 of Loads 4-5; segment 1 and portion of segment 2 of Storage 1.

In the example shown in table 610, by Subinterval 4 the total required reduction in demand is 200 kW, with segments requested in all five loads and one of the two storage devices. Further segments can be requested for additional subintervals according to the priority information provided. In table 610, additional segments are requested (with the exception of Subinterval 6) until Subinterval 9, at which point the total required reduction in demand has been decreased by 70 kW, allowing segments in priority tiers 7-9 to be released. By Subinterval 12, the required reduction is 0 and all of the previously requested segments have been released.

If a certain load or energy storage system is unavailable to provide power for any reason, such as production constraints or insufficient battery charge, the unit can be skipped by the prioritization schema. Requested power can be released (e.g., where the available power value is positive, rather than negative) in reverse order.

### Operating Environment

Unless otherwise specified in the context of specific examples, described techniques and tools may be implemented by any suitable computing devices, including, but not limited to, industrial computers, laptop computers, desktop computers, smart phones, tablet computers, and/or the like. Described techniques and tools also may be implemented in virtual computing environments.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location.

FIG. 7 is a block diagram that illustrates aspects of an illustrative computing device 700 appropriate for use in accordance with embodiments of the present disclosure. The description below is applicable to servers, personal computers, mobile phones, smart phones, tablet computers, embedded computing devices, and other currently available or yet to be developed devices that may be used in accordance with embodiments of the present disclosure.

In its most basic configuration, the computing device 700 includes at least one processor 702 and a system memory 704 connected by a communication bus 706. Depending on the exact configuration and type of device, the system memory 704 may be volatile or nonvolatile memory, such as read only memory (“ROM”), random access memory (“RAM”), EEPROM, flash memory, or other memory technology. Those of ordinary skill in the art and others will recognize that system memory 704 typically stores data and/or program modules that are immediately accessible to and/or currently being operated on by the processor 702. In this regard, the processor 702 may serve as a computational center of the computing device 700 by supporting the execution of instructions.

As further illustrated in FIG. 7, the computing device 700 may include a network interface 710 comprising one or more components for communicating with other devices over a network. Embodiments of the present disclosure may access basic services that utilize the network interface 710 to perform communications using common network protocols. The network interface 710 may also include a wireless network interface configured to communicate via one or more wireless communication protocols, such as Wi-Fi, 2G, 3G, 4G, LTE, WiMAX, Bluetooth, and/or the like.

In the illustrative embodiment depicted in FIG. 7, the computing device 700 also includes a storage medium 708. However, services may be accessed using a computing device that does not include functionality persisting data to a local storage medium. Therefore, the storage medium 708 depicted in FIG. 7 is optional. In any event, the storage medium 708 may be volatile or nonvolatile, removable or nonremovable, implemented using any technology capable of storing information such as, but not limited to, a hard drive, solid state drive, CD ROM, DVD, or other disk storage, magnetic tape, magnetic disk storage, and/or the like.

As used herein, the term “computer readable medium” includes volatile and nonvolatile and removable and nonremovable media implemented in any method or technology capable of storing information, such as computer readable instructions, data structures, program modules, or other data. In this regard, the system memory 704 and storage medium 708 depicted in FIG. 7 are examples of computer readable media.

For ease of illustration and because it is not important for an understanding of the claimed subject matter, FIG. 7 does not show some of the typical components of many computing devices. In this regard, the computing device 700 may include input devices, such as a keyboard, keypad, mouse, trackball, microphone, video camera, touchpad, touchscreen, electronic pen, stylus, and/or the like. Such input devices may be coupled to the computing device 700 by wired or wireless connections including RF, infrared, serial, parallel, Bluetooth, USB, or other suitable connection protocols using wireless or physical connections.

In any of the described examples, input data can be captured by input devices and processed, transmitted, or stored (e.g., for future processing). Input devices can be separate from and communicatively coupled to computing device 700 (e.g., a client device), or can be integral components of the computing device 700. In some embodiments, multiple input devices may be combined into a single, multifunction input device (e.g., a video camera with an integrated microphone). Any suitable input device either currently known or developed in the future may be used with systems described herein.

The computing device 700 may also include output devices such as a display, speakers, printer, etc. The output devices may include video output devices such as a display or touchscreen. The output devices also may include audio output devices such as external speakers or earphones. The output devices can be separate from and communicatively coupled to the computing device 700, or can be integral components of the computing device 700. In some embodiments, multiple output devices may be combined into a single device (e.g., a display with built in speakers). Further, some devices (e.g., touchscreens) may include both input and output functionality integrated into the same input/output device. Any suitable output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub modules. The computing logic can be stored in any type of computer readable medium (e.g., a non transitory medium such as a memory or storage medium) or computer storage device and be stored on and executed by one or more general purpose or special purpose processors, thus creating a special purpose computing device configured to provide functionality described herein.

FIG. 8 is a block diagram that illustrates aspects of an alternate computing environment 800 appropriate for use in accordance with embodiments of the present disclosure. In this example, the various integrated power demand management techniques described herein are implemented on a programmable logic controller (PLC) 805. As is well understood in the art, a PLC is a specialized computer control system configured to execute software which continuously gathers data on the state of input devices to control the state of output devices. A PLC typically includes a processor 810 (which may include multiple processor cores and volatile memory) and a storage medium 820 comprising an application program executing the integrated demand management system described herein.

The PLC 805 further includes one or more input/output (I/O) ports 815 for connecting to other devices in the automation system. Through these ports 815, the PLC 805 gathers power data from external sources such as power meters, energy storage devices, and power loads (e.g., an HVAC system, a pump motor, a furnace, process controls, etc.) for processing by the integrated demand management system. The exact technique used for data gathering data from these external sources will vary depending on the networking capabilities of the PLC 805. For example, in some embodiments the PLC 805 is wired directly to the external sources, while in other embodiments wireless networking functionality (e.g., Wi-Fi, 2G, 3G, 4G, LTE, WiMAX, Bluetooth, and/or the like.) may be used to connect the PLC 805 and external sources.

The PLC 805 is configured to transmit power demand data over a Network 825 (the Internet) to cloud-based computing environment, represented in FIG. 8 by Server 835. In some instances, the PLC 805 may be configured to communicate directly with the Server 835; however, generally, the PLC 805 operates as part of a lager computing environment for a facility and other devices in the environment serve as intermediaries for transferring data with sources outside of the facility. The power demand data communicated by the PLC 805 may include any data gathered or generated by the integrated demand management system on the PLC 805. Thus, for example, the transmitted power demand data may include measurements from a local power meter, power loads, or local energy sources, as well as corresponding demand limit set-points and predicted power demand values. Additionally, in some instances, the transmitted data may include information derived from the measurements by the integrated demand management system.

Continuing with reference to FIG. 8, once the data is received at the Server 835, it may be stored locally and presented in a graphical user interface (GUI) for display on a User computer 830. This data may be presented in a textual form or the Server 835 may produce one or more graphical plots to depict the information. In some embodiments, the GUI additionally allows a user (via User Computer 830) to manipulate parameters of the integrated demand management system on the PLC 805. For example, in some embodiments, the user can utilized the GUI to modify the demand management actions that are available to integrated demand management system.

### Extensions and Alternatives

It will be understood that although the illustrative systems and techniques are described in the context of a facility that consumes power provided by a power utility via a power grid, the principles described herein are also applicable to other power consumption scenarios. For example, a facility that generates its own power and is not connected to a public power grid may, nevertheless, benefit from the integrated demand management systems and techniques described herein. In such a scenario, the off-grid facility may have a primary power source along with one or more secondary power sources, such as batteries. The primary power source may supply much of the off-grid facility's power needs, but unusually high demand levels may damage the power source or lead to service disruption. In such a facility, an integrated demand management system can allow the facility to manage loads and generate power from secondary sources to avoid undesirable demand levels. This scenario also emphasizes the fact that the technological solutions described herein provide technological benefits in terms of demand management, and do not merely serve to reduce cost in the form of utility charges. A facility may have no utility charges at all, but may still obtain a technological benefit from the demand management systems and techniques described herein. It will be understood that although some time periods are described herein in terms of “billing” periods and “debit” periods to illustrate a common usage scenario, the systems and techniques described herein are not inherently financial in nature, and can be characterized in other ways within the scope of the present disclosure.

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

The detailed description set forth above in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the present disclosure, numerous specific details are set forth in order to provide a thorough understanding of illustrative embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

What is claimed is:

1. A computer-implemented method for managing power demand, the method comprising:
obtaining, by a computer system, power demand information for a facility comprising one or more local energy storage devices and one or more power loads;
selecting, by the computer system, a demand management action from a plurality of available demand management actions based on the power demand information, wherein the available demand management actions comprise at least one power load action and at least one energy storage device action; and
performing, by the computer system, the selected demand management action.

2. The method of claim 1, wherein the power demand information comprises a demand limit set-point and a predicted power demand value.

3. The method of claim 2, further comprising calculating an available power value as a difference between the predicted power demand value and the demand limit set-point, wherein the selected demand management action is based at least in part on the available power value.

4. The method of claim 3, wherein if the available power value is negative, the selected demand management action is selected from a group comprising increasing a load reduction, reducing charging power, and increasing power generation.

5. The method of claim 3, wherein if the available power value is positive, the selected demand management action is selected from a group comprising decreasing a load reduction, charging an energy storage device, and decreasing power generation.

6. A computer-implemented method for managing power demand, the method comprising:
obtaining, by a computer system, power demand information for a time period comprising a plurality of intervals, wherein the power demand information comprises a demand limit set-point for the time period and a predicted power demand value for the time period;
determining, by the computer system, that the predicted power demand value exceeds the demand limit set-point; and
drawing from available power to reduce the power demand for the time period, wherein the available power comprises one or more local power sources and available reduction of one or more of the power loads.

7. The method of claim 6, wherein drawing from the available power is based on priority information.

8. The method of claim 7, wherein the priority information comprises priority information for the power loads.

9. The method of claim 8, wherein the priority information for the power loads comprises a plurality of prioritized segments.

10. The method of claim 7, wherein the priority information comprises priority information for the local power sources.

11. The method of claim 10, wherein the priority information for the local power sources comprises a plurality of prioritized segments.

12. The method of claim 7, wherein the priority information comprises priority information for the power loads and the local power sources.

13. The method of claim 12, wherein the priority information for the power loads and the local power sources comprises a plurality of prioritized segments.

14. The method of claim 6, wherein drawing from the available power comprises reducing at least one of the power loads for at least one of the intervals.

15. The method of claim 14, wherein the at least one power load is a constrained power load.

16. The method of claim 6, wherein drawing from the available power comprises generating power from at least one of the local power sources.

17. The method of claim 16, wherein the at least one local power source comprises an energy storage device.

18. A system for managing power demand, the system comprising:
one or more ports configured to obtain power demand information for a facility comprising one or more local energy storage devices and one or more power loads; and
one or more processors configured to:
select a demand management action from a plurality of available demand management actions based on the power demand information, wherein the available demand management actions comprise at least one power load action and at least one energy storage device action, and
perform the selected demand management action.

19. The system of claim 18, wherein the power demand information comprises a demand limit set-point and a predicted power demand value.

20. The system of claim 19, wherein the one or more processors are further configured to:
calculate an available power value as a difference between the predicted power demand value and the demand limit set-point, wherein the selected demand management action is based at least in part on the available power value.
